(19) United States
(12) Patent Application Publication
(10) Pub. No.: US 2011/0054912 A1
(43) Pub. Date: Mar. 3, 2011

(54) SYSTEM AND METHOD OF STORING TELEPHONE CONVERSATIONS

(76) Inventor: CHRISTOPHER ANTHONY SILVA, Little Egg Harbor, NJ (US)

(21) Appl. No.: 12/552,217

(22) Filed: Sep. 1, 2009

(51) Int. Cl. H04L 12/58; G10L 19/00

(52) U.S. Cl. 704/500; 455/412.1; 704/E19.009

(57) ABSTRACT

A method and system of storing telephone conversation data to a third party database storage unit is disclosed. The method includes detecting a telephone call initiated in a mobile telephone, recording telephone conversation data, detecting a termination of the telephone call, and transferring the recorded telephone conversation data to a third party database storage unit. The system includes an application program interface installed on a mobile telephone, an internet gateway, and a third party database storage unit configured to store data recorded by the application program interface.

### BACKGROUND OF THE INVENTION

The present invention generally relates to data storage, and more particularly, to archiving mobile telephone call data.

Increasing popularity in conducting business via mobile telephones has led to, in some instances, in the loss of or poor record keeping of discussed material. Two or more people conducting, for example, a business call from various locations may discuss specific transactional details that may be lost or inaccurately remembered once the call is terminated.

Additionally, some mobile telephones may be equipped with multiple applications requiring extensive memory storage. Thus, the distribution of data files and management of data space within a mobile telephone may be at a premium.

As can be seen, there is a need for a method and system of recording telephone conversations for accurate record keeping.

### SUMMARY OF THE INVENTION

In one aspect of the present invention, a method of storing telephone conversation data comprises detecting a telephone call initiated in a mobile telephone producing the telephone conversation data; recording the telephone conversation data; detecting a termination of the telephone call; and transferring the recorded telephone conversation data to a third party database.

In another aspect of the present invention, a system for storing telephone conversation data comprises an application program interface installed on a mobile telephone configured to store data associated with a telephone call initiated by or received by the mobile telephone; an internet gateway configured to receive wireless signal transmissions of the data from the mobile telephone; and a database storage unit connected to the internet gateway wherein the database storage unit is located externally of the mobile telephone and wherein the database storage unit is configured to store the data received from the internet gateway.

These and other features, aspects and advantages of the present invention will become better understood with reference to the following drawings, description and claims.

### BRIEF DESCRIPTION OF THE DRAWINGS

FIG. 1 is a block diagram depicting a system according to an exemplary embodiment of the present invention; and

FIG. 2 is a flowchart illustrating a series of steps according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a method and system for storing data associated with telephone conversations to a third party site for archival and future playback.

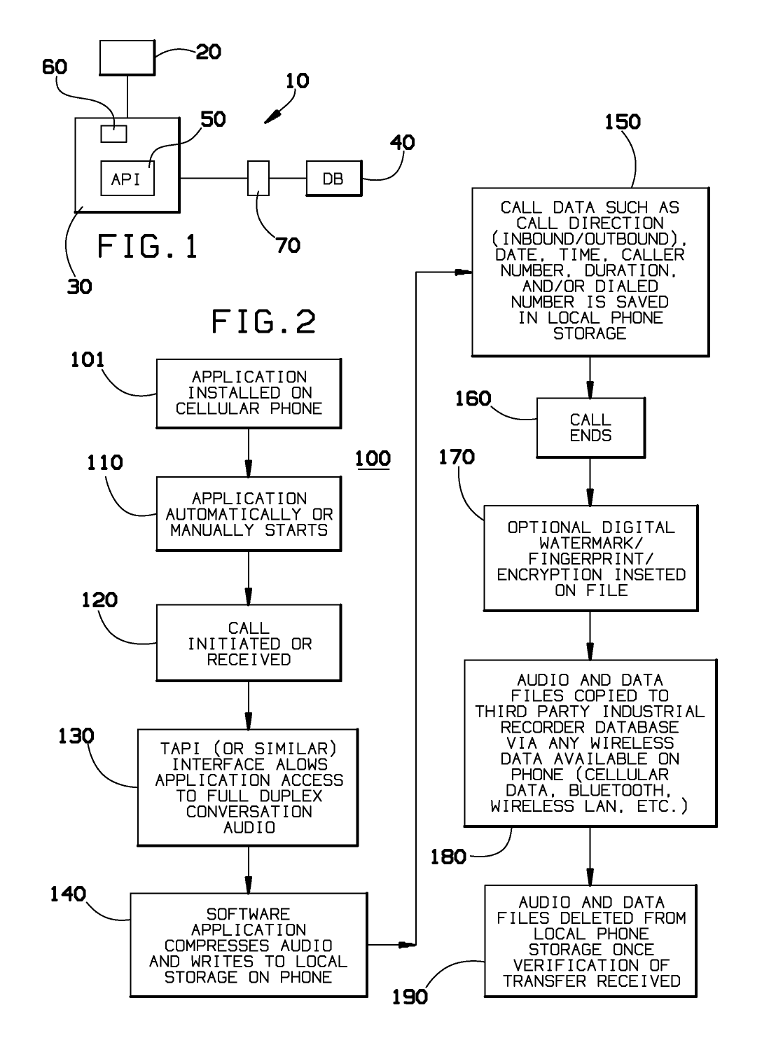

Referring to FIG. 1, a system 10 according to an exemplary embodiment of the present invention, may generally include a mobile telephone 30, an internet gateway 70 and a third party database storage unit 40. The mobile telephone 30 may further include a memory storage module 60 and an application program interface 50, such as a telephony application program interface (TAPI). The system 10 may also include a second telephone unit 20 that may either send or receive a telephone call from the mobile telephone 30. It will be understood that the telephone unit 20 may be either a landline connected telephone or another mobile telephone.

The application program interface 50 may be resident on the mobile telephone 30 and run in the background while having no visual or audible indication that it is running. A user interface (not shown) may be password protected. The application program interface 50 may allow the application access to a full duplex telephone conversation of audio data. The application program interface 50 may compress the audio data using any standard or nonstandard audio compression standards such as GSM, G.729a, G.711, etc.

Other call data associated with a telephone call may include a call direction for example, inbound vs. outbound, a duration of a call, a date and time the call began, a caller identification, and a dialed number. The call data may be captured and stored in the audio file and/or accompany the audio file as a separate data file. The telephone audio data and call data associated with the telephone call may be temporarily stored in the memory storage module 60. Upon completion of the call and creation of the data file(s), the application will optionally insert a digital fingerprint, watermark, or encryption for integrity purposes and then copy the file(s) to the 3rd party database server via any wireless connection available to the cellular phone that will connect to the database server.

Referring now to FIGS. 1 and 2, a method 100 according to an exemplary embodiment of the present invention is described. The method 100 may in step 101, identify that an application program interface 50 is installed on a mobile telephone 30. An application program interface 50 may be automatically started or manually started in step 110. In step 120, an initiated or received telephone call in the mobile telephone 30 may be detected. The application program interface 50 may access and record the telephone conversation and associated data occurring during operation of the mobile telephone 50 by a first user conducting a call with a second user on the telephone unit 20. Instep 140, audio data associated with the telephone conversation may be compressed into a waveform audio format and stored in the memory storage module 60. Other telephone conversation data associated with the telephone call may be accessed and stored in the memory storage module 60 in step 150. The other telephone conversation data associated with the telephone call may include call direction, date of the call, time of the call, a caller number of the telephone unit 20, and duration of the call. In step 160, termination of the telephone call may be recognized. Instep 170, the telephone conversation data may be watermarked, fingerprinted, or encrypted within the memory storage module 60. In step 180, the telephone conversation data may be transmitted wirelessly to the internet gateway 70 and transferred for storage into the third party database storage unit 40. In step 190, the telephone conversation data may be deleted from the memory storage module 60 once verification of the transfer of the telephone conversation data to the third party database storage unit 40 is received by the mobile telephone 50.

It should be understood, of course, that the foregoing relates to exemplary embodiments of the invention and that modifications may be made without departing from the spirit and scope of the invention as set forth in the following claims.

I claim:

1. A method of storing telephone conversation data, comprising:
detecting a telephone call initiated in a mobile telephone producing the telephone conversation data;
recording the telephone conversation data;
detecting a termination of the telephone call; and
transferring the recorded telephone conversation data to a third party database storage unit.

2. The method of claim 1, further comprising compressing the telephone conversation data into a waveform audio format.

3. The method of claim 1, further comprising encrypting the recorded telephone conversation data.

4. The method of claim 1, wherein the telephone conversation data is in an audio format.

5. The method of claim 1, further comprising deleting the telephone conversation data from a memory storage contained within the mobile telephone.

6. The method of claim 1, wherein the telephone conversation data includes a date of the telephone call, a time of the telephone call, and a caller number of the telephone call.

7. The method of claim 1, wherein transferring the recorded telephone conversation data is performed wirelessly.

8. A system for storing telephone conversation data, comprising:
an application program interface installed on a mobile telephone configured to store data associated with a telephone call initiated by or received by the mobile telephone;
an internet gateway configured to receive wireless signal transmissions of the data from the mobile telephone; and
a third party database storage unit connected to the internet gateway wherein the database storage unit is located externally of the mobile telephone and wherein the third party database storage unit is configured to store the data received from the internet gateway.

9. The system of claim 8 wherein the application program is further configured to store a date of the telephone call, a time of the telephone call, and a caller number of the telephone call for transmission to the third party database storage unit.

10. The system of claim 8 wherein the application program is further configured to attach a digital fingerprint to the data.
